(19) United States
(12) Patent Application Publication
(10) Pub. No.: US 2026/0122647 A1
(43) Pub. Date: Apr. 30, 2026

(54) OPERATING A USER EQUIPMENT IN OR WITH A MOBILE COMMUNICATION NETWORK

(71) Applicant: Deutsche Telekom AG, Bonn (DE)

(72) Inventor: Axel Klatt, Cologne (DE)

(21) Appl. No.: 19/489,610

(22) PCT Filed: Jun. 13, 2024
(86) PCT No.: PCT/EP2024/066438

§ 371 Date: Dec. 3, 2025

(30) Foreign Application Priority Data
Jun. 21, 2023 (EP) 23180596.1

(51) Int. Cl. H04W 72/23; H04W 72/21; H04W 76/27

(52) U.S. Cl. CPC H04W 72/23; H04W 72/21; H04W 76/27

(57) ABSTRACT

A method for operating a user equipment in or with a mobile communication network includes: in a first step, a base station entity transmits, and the user equipment receives, a transmission opportunity information to invite or incite data transmission and/or traffic due to a currently detected or anticipated situation of comparatively low load of either the mobile communication network or the air interface between the user equipment and the base station entity; and in a second step, data transmission in either uplink direction or in downlink direction occurs, between the user equipment and the base station entity, according to a possibility or possibilities as indicated by means of the transmission opportunity information. The transmission opportunity information is transmitted as a bitmap information.

### CROSS-REFERENCE TO PRIOR APPLICATIONS

This application is a U.S. National Phase application under 35 U.S.C. § 371 of International Application No. PCT/EP2024/066438, filed on Jun. 13, 2024, and claims benefit to European Patent Application No. EP 23180596.1, filed on Jun. 21, 2023. The International Application was published in English on Dec. 26, 2024 as WO 2024/260844 A1 under PCT Article 21 (2).

### FIELD

The present invention relates a method for operating a user equipment in or with a mobile communication network comprising a radio access network, wherein the radio access network comprises at least one base station entity, wherein data transmission is able to be conducted, between the user equipment and the base station entity and using an air interface between them, in downlink direction, involving data being transmitted by the base station entity and received by the user equipment, and/or in uplink direction, involving data being transmitted by the user equipment and received by the base station entity.

Furthermore, the present invention relates to a user equipment for being operated in or with a mobile communication network, wherein the mobile communication network comprises a radio access network, wherein the radio access network comprises at least one base station entity, wherein data transmission is able to be conducted, between the user equipment and the base station entity and using an air interface between them, in downlink direction, involving data being received by the user equipment, and/or in uplink direction, involving data being transmitted by the user equipment.

Additionally, the present invention relates to a system or to a telecommunications network for operating a user equipment in or with a mobile communication network comprising a radio access network, wherein the radio access network comprises at least one base station entity, wherein data transmission is able to be conducted, between the user equipment and the base station entity and using an air interface between them, in downlink direction, involving data being transmitted by the base station entity and received by the user equipment, and/or in uplink direction, involving data being transmitted by the user equipment and received by the base station entity.

Furthermore, the present invention relates to a program and to a computer-readable medium for operating a user equipment in or with a telecommunications network comprising a radio access network according to exemplary embodiments of the inventive method.

The present invention relates to the area of telecommunications networks, especially wireless telecommunications networks or mobile communication networks.

### BACKGROUND

Conventionally, mobile communication networks (or cellular networks) are typically designed such that data-especially user plane data—are able to be transmitted whenever the user equipment (i.e. especially an application of or related to the user equipment) wants to either send data towards the mobile communication network or receive data from the mobile communication network, especially via an access network or radio access network of or associated or connected to the mobile communication network: this general pattern (of data transmission on demand of the user equipment) being rather similar to IP-based networks where clients are able to request to be either provided with (user plane) date or to transmit user plane data.

Generally, the principle of cellular mobile communication networks has always been that once the user equipment has access to establish an radio resource control, RRC. connection with the mobile network, all services are, in principle, allowed for the respective user equipment. Historically, the access has only been controlled by the access class barring, ACB, mechanism. Later service specific access barring/control, SSAC, has been introduced, still being applied for the user equipment accessing a radio cell in order to establish an radio resource control connection.

Since the times of the definition and deployment of the LTE (long term evolution) standard, the user equipments are more of less continuously connected or, at least, transit often between idle and connected states (radio resource control states). Thus, the new RRC state inactive has been introduced, where the user equipment and the network keep the RRC connection and a faster, less signaling-heavy transition to the RRC connected state is possible: the RRC inactive state is also applicable in 5G (NR).

Generally, there are proposals that have been made, especially in view of off-peak data transmission (e.g. based on a time (window), an indication is sent to the user equipment). Additionally, for internet-of-things services, a delay tolerant access has been proposed, which means that certain internet-of-things traffic is not so critically needed that it immediately needs to be sent but is able to be delayed (by the network assigning uplink grants to such user equipments) for a couple of seconds.

Hence, beyond that, there is presently no conventionally known active control architecture available that would enable to control—towards the user equipment in a cellular network—the transmission of data either towards the user equipment (i.e. in downlink direction) or from the user equipment towards the mobile communication network (or the radio access network: i.e. in uplink direction), i.e. regarding a control architecture towards the user equipment as to when the user equipment should be allowed to actively transmit data (or receive data) based on parameters such as (network) load and/or radio access network load, capacity and energy consideration over a longer term of, e.g. a plurality of seconds, minutes or even hours. Obviously, the control in uplink direction (i.e. for uplink data transmission) is always on the network side (in particular the radio access network), but presently, in cellular network or mobile communication networks, there is no such control architecture available in order to control data transmission functionality and especially to control or to negotiate a temporal shift of data transmission.

### SUMMARY

In an exemplary embodiment, the present invention provides a method for operating a user equipment in or with a mobile communication network comprising a radio access network. The radio access network comprises at least one base station entity. Data transmission is able to be conducted, between the user equipment and the base station entity and using an air interface between them, in downlink direction, involving data being transmitted by the base station entity and received by the user equipment, or in uplink direction, involving data being transmitted by the user equipment and received by the base station entity. In order to use the user equipment with the mobile communication network the method comprises the following steps: in a first step, the base station entity transmits, and the user equipment receives, a transmission opportunity information to invite or incite data transmission and/or traffic due to a currently detected or anticipated situation of comparatively low load of either the mobile communication network or the air interface between the user equipment and the base station entity, wherein the transmission opportunity information indicates the possibility for the user equipment to transmit data in uplink direction or the possibility for the user equipment to request the transmission of data in downlink direction; and in a second step, data transmission in either uplink direction or in downlink direction occurs, between the user equipment and the base station entity, according to the possibility or possibilities as indicated by means of the transmission opportunity information. The transmission opportunity information is transmitted as a bitmap information, wherein the bitmap information refers to such configured network slices, and either indicates, to the user equipment and regarding each one of such configured network slices, the possibility to use transmit data in uplink direction or the possibility for the user equipment to request the transmission of data in downlink direction, wherein the bitmap information comprises, regarding each one of such configured network slices, either one bit regarding the possibility to use transmit data in uplink direction or the possibility for the user equipment to request the transmission of data in downlink direction, or one bit regarding the possibility to use transmit data in uplink direction and another bit regarding the possibility for the user equipment to request the transmission of data in downlink direction.

### BRIEF DESCRIPTION OF THE DRAWINGS

Subject matter of the present disclosure will be described in even greater detail below based on the exemplary figures. All features described and/or illustrated herein can be used alone or combined in different combinations. The features and advantages of various embodiments will become apparent by reading the following detailed description with reference to the attached drawings, which illustrate the following:

FIG. 1 schematically illustrates a telecommunications network comprising an access network, a core network and a user equipment, wherein the radio access network comprises at least one base station entity and wherein data transmission is able to be conducted, between the user equipment and the base station entity in downlink direction or in uplink direction.

### DETAILED DESCRIPTION

Exemplary embodiments of the present invention provide an effective and simple approach for operating a user equipment in or with a mobile communication network in a manner such that it is possible to actively control—towards the user equipment—the transmission of data either towards the user equipment (i.e. in downlink direction) or from the user equipment towards the mobile communication network (or the radio access network: i.e. in uplink direction), especially regarding as to when the user equipment is allowed to actively transmit data (or receive data)—especially based on parameters such as (network) load and/or radio access network (or (local) air interface) load, capacity and energy consideration-over a longer term of, e.g. a plurality of seconds, minutes or even hours. Further exemplary embodiments of the present invention provide a corresponding user equipment, a corresponding system or telecommunications network, and a corresponding program and computer-readable medium.

In an exemplary embodiment, the present invention provides a method for operating a user equipment in or with a mobile communication network comprising a radio access network, wherein the radio access network comprises at least one base station entity, wherein data transmission is able to be conducted, between the user equipment and the base station entity and using an air interface between them, in downlink direction, involving data being transmitted by the base station entity and received by the user equipment, and/or in uplink direction, involving data being transmitted by the user equipment and received by the base station entity,
wherein, in order to use the user equipment with the mobile communication network, especially with the base station entity, the method comprises the following steps:
   in a first step, the base station entity transmits, and the user equipment receives, a transmission opportunity information, wherein the transmission opportunity information indicates the possibility for the user equipment to transmit data in uplink direction and/or the possibility for the user equipment to request the transmission of data in downlink direction,
   in a second step, data transmission in either uplink direction or in downlink direction or in both uplink and downlink direction occurs, between the user equipment and the base station entity, according to the possibility or possibilities as indicated via the transmission opportunity information.

It is thereby advantageously possible, according to the present invention, to provide a fine-grained control architecture and control signaling in order to possibly shift data transmissions in time and to enable data transmission more efficiently, especially in a more energy-efficient manner. Especially according to the present invention, the control signaling regarding such data transmission is especially based on standard protocols to control the data activity of the user equipment generally and especially not limited to the situation that the user equipment has already initiated a connection with the mobile communication network.

Especially, according to the present invention, it is rather aimed at triggering or inviting traffic from the user equipment-especially traffic that is not that critical such as it would needed to be immediately transmitted (which might be the case of (text) messages), but more like bulk data which can be also sent minutes or even hours later-instead of restricting certain data transmissions or traffic generated by the user equipment. Advantageously, this is able to be achieved by sending “activation bits” on a granularity of radio bearers and/or network slices to the respective user equipments in a radio cell: a trigger for such control bits might especially be low utilization of the radio network or the availability of a high amount of eco-friendly power (from solar, wind, etc.) such that an CO₂-friendly communication environment is able to be realized.

According to the present invention, it is assumed that the user equipment is able to communicate with the mobile communication network, i.e. data transmission is able to be conducted, between the user equipment and the base station entity and using an air interface between them, typically both in downlink direction-involving data being transmitted by the base station entity and received by the user equipment—and in uplink direction-involving data being transmitted by the user equipment and received by the base station entity. The exemplary embodiments of the inventive method provides, in a first step, that the base station entity transmits (and the user equipment receives) a transmission opportunity information, wherein the transmission opportunity information indicates the possibility for the user equipment to transmit data in uplink direction and/or the possibility for the user equipment to request the transmission of data in downlink direction. In a second step, the data transmission (in either uplink direction or in downlink direction or in both uplink and downlink direction) occurs, between the user equipment and the base station entity, according to the possibility or possibilities as indicated via the transmission opportunity information.

According to the present invention, it is advantageously possible and preferred that the transmission opportunity information indicates the possibility for the user equipment to transmit data in uplink direction and/or the possibility for the user equipment to request the transmission of data in downlink direction applying a certain granularity via using at least one out of the following:
the transmission opportunity information indicates the possibility or possibilities to transmit data to be generally available,
the transmission opportunity information is related to or inviting one traffic type or certain traffic types, especially broadband traffic or internet-of-things traffic,
the transmission opportunity information is related to or inviting traffic being related to one 5QI value or to certain 5QI values,
the transmission opportunity information is related to or inviting traffic being related to or transmitted using one bearer type or to certain bearer types,
the transmission opportunity information is related to or inviting traffic being related to or transmitted using one network slice or to certain network slices, especially allowed network slices and/or subscribed network slices and/or active network slices.

According to the present invention, it is thereby advantageously possible that exemplary embodiments of the inventive method are able to be performed in a flexible and efficient manner.

According to the present invention, it is furthermore advantageously possible and preferred that the transmission opportunity information is used-via indicating the possibility for the user equipment to transmit data in uplink direction and/or the possibility for the user equipment to request the transmission of data in downlink direction—to invite or incite data transmission and/or traffic, especially due to a currently detected or anticipated situation of comparatively low load of either the mobile communication network or the air interface between the user equipment and the base station entity and/or due to a currently detected or anticipated situation of comparatively low data transmission costs especially in terms of energy prices, especially in case of abundant eco-friendly power availability,
wherein the invited or incited data transmission and/or traffic especially involves delay-tolerant traffic and/or traffic that is either expected to definitively need to be transmitted at some later point in time, or traffic where, at least partly, only a potential need to be transmitted is expected,
wherein the invited or incited data transmission and/or traffic especially involves software updates or firmware updates or map updates, logging data, especially from machines or vehicles and especially for post-processing.

According to the present invention, it is thereby advantageously possible that exemplary embodiments of the inventive method are able to be performed in a flexible and efficient manner.

According to the present invention, it is furthermore advantageously possible and preferred that—especially in case that the transmission opportunity information refers to the possibility or possibilities to use one or a plurality of network slices—the transmission opportunity information is transmitted as a bitmap information, especially a bitmap information transmitted using a suitable system information block, SIB,
wherein the bitmap information is especially referring to specific network slices, especially using a reference to one or a plurality of network slices and/or of pieces of slice/service type, SST, information of network slices,
wherein the bitmap information especially comprises up to 256 bits and is potentially able to address up to 256 different network slices and/or pieces of slice/service type, SST, information.

According to the present invention, it is thereby advantageously possible that exemplary embodiments of the inventive method are able to be performed in a flexible and efficient manner.

According to the present invention, it is furthermore advantageously possible and preferred that the base station entity and/or the mobile communication network transmits, to the user equipment, one or a plurality of configured network slices,
wherein the bitmap information, as the transmission opportunity information, refers to such configured network slices, and especially either indicates, to the user equipment and regarding each one of such configured network slices, the possibility to use transmit data in uplink direction and/or the possibility for the user equipment to request the transmission of data in downlink direction,
wherein especially the bitmap information comprises, regarding each one of such configured network slices,
   either one bit regarding the possibility to use transmit data in uplink direction and/or the possibility for the user equipment to request the transmission of data in downlink direction,
   or one bit regarding the possibility to use transmit data in uplink direction and another bit regarding the possibility for the user equipment to request the transmission of data in downlink direction.

According to the present invention, it is thereby advantageously possible that exemplary embodiments of the inventive method are able to be performed in a flexible and efficient manner.

According to the present invention, it is furthermore advantageously possible and preferred that the transmission opportunity information comprises a start time indication and/or an end time indication and/or a data volume or data amount indication regarding the invitation or the incitation for the user equipment to transmit data in uplink direction and/or the invitation or the incitation for the user equipment to request the transmission of data in downlink direction,
especially a start time indication and/or an end time indication and/or a data volume or data amount indication per configured network slice,
wherein especially the start time indication is implicitly provided via transmitting the transmission opportunity information and wherein the transmission opportunity information comprises a duration information indicating the end time information, especially a duration information per configured network slice,
wherein especially the duration information indicates-regarding the invitation or the incitation for the user equipment to transmit data in uplink direction and/or the invitation or the incitation for the user equipment to request the transmission of data in downlink direction
   a duration of 10 seconds, or of 20 seconds, or of 30 seconds, or of 45 seconds, or of 60 seconds, or of 90 seconds, or of 2 minutes, or of 3 minutes, or of 4 minutes, or of 5 minutes, or of 6 minutes, or of 8 minutes, or of 10 minutes, or of 15 minutes, or of 20 minutes, or of 25 minutes, or of 30 minutes, or of 45 minutes, or of 60 minutes, or of 90 minutes, or of 2 hours, or of 3 hours, or of 4 hours, or of 5 hours, or of 6 hours.

According to the present invention, it is thereby advantageously possible that exemplary embodiments of the inventive method are able to be performed in a flexible and efficient manner.

According to the present invention, it is furthermore advantageously possible and preferred that the user equipment is able to have at least one of the following radio resource control states:
idle,
inactive and
connected,
   wherein the transmission opportunity information is especially used and/or applied, by the user equipment, if in a radio resource control state idle or inactive or connected, wherein especially the transmission opportunity information is transmitted using common control signaling and/or dedicated control signaling, wherein especially common control signaling is used in case that the user equipment is currently in radio resource control states idle or inactive and wherein especially dedicated control signaling is used in case that the user equipment is currently in radio resource control state connected.

According to the present invention, it is thereby advantageously possible that exemplary embodiments of the inventive method are able to be performed in a flexible and efficient manner.

Furthermore, the present invention relates to a user equipment for being operated in or with a mobile communication network, wherein the mobile communication network comprises a radio access network, wherein the radio access network comprises at least one base station entity, wherein data transmission is able to be conducted, between the user equipment and the base station entity and using an air interface between them, in downlink direction, involving data being received by the user equipment, and/or in uplink direction, involving data being transmitted by the user equipment,
wherein, in order to use the user equipment with the mobile communication network, especially with the base station entity, the user equipment is configured such that:
   the user equipment receives a transmission opportunity information, wherein the transmission opportunity information indicates the possibility for the user equipment to transmit data in uplink direction and/or the possibility for the user equipment to request the transmission of data in downlink direction,
   data transmission in either uplink direction or in downlink direction or in both uplink and downlink direction occurs, between the user equipment and the base station entity, according to the possibility or possibilities as indicated via the transmission opportunity information.

Additionally, the present invention relates to a system or to a telecommunications network for operating a user equipment in or with a mobile communication network comprising a radio access network, wherein the radio access network comprises at least one base station entity, wherein data transmission is able to be conducted, between the user equipment and the base station entity and using an air interface between them, in downlink direction, involving data being transmitted by the base station entity and received by the user equipment, and/or in uplink direction, involving data being transmitted by the user equipment and received by the base station entity,
wherein, in order to use the user equipment with the mobile communication network, especially with the base station entity, the system or mobile communication network is configured such that:
   in a first step, the base station entity transmits, and the user equipment receives, a transmission opportunity information, wherein the transmission opportunity information indicates the possibility for the user equipment to transmit data in uplink direction and/or the possibility for the user equipment to request the transmission of data in downlink direction,
   in a second step, data transmission in either uplink direction or in downlink direction or in both uplink and downlink direction occurs, between the user equipment and the base station entity, according to the possibility or possibilities as indicated via the transmission opportunity information.

Additionally, the present invention relates to a program comprising a computer readable program code which, when executed on a computer or on a user equipment, or on a base station entity or on a radio access network node, or in part on a user equipment and/or in part on a base station entity and/or in part on a radio access network node, causes the computer or the user equipment or the base station entity or the radio access network node to perform exemplary embodiments of the inventive method.

Still additionally, the present invention relates to a computer-readable medium comprising instructions which, when executed on a computer or on a user equipment, or on a base station entity or on a radio access network node, or in part on a user equipment and/or in part on a base station entity and/or in part on a radio access network node, causes the computer or the user equipment or the base station entity or the radio access network node to perform exemplary embodiments of the inventive method.

These and other characteristics, features and advantages of the present invention will become apparent from the following detailed description, taken in conjunction with the accompanying drawings, which illustrate, by way of example, the principles of the invention. The description is given for the sake of example only, without limiting the scope of the invention. The reference figures quoted below refer to the attached drawings.

The present invention will be described with respect to particular embodiments and with reference to certain drawings but the invention is not limited thereto but only by the claims. The drawings described are only schematic and are non-limiting. In the drawings, the size of some of the elements may be exaggerated and not drawn on scale for illustrative purposes.

Where an indefinite or definite article is used when referring to a singular noun, e.g. “a”, “an”, “the”, this includes a plural of that noun unless something else is specifically stated.

Furthermore, the terms first, second, third and the like in the description and in the claims are used for distinguishing between similar elements and not necessarily for describing a sequential or chronological order. It is to be understood that the terms so used are interchangeable under appropriate circumstances and that the embodiments of the invention described herein are capable of operation in other sequences than described or illustrated herein.

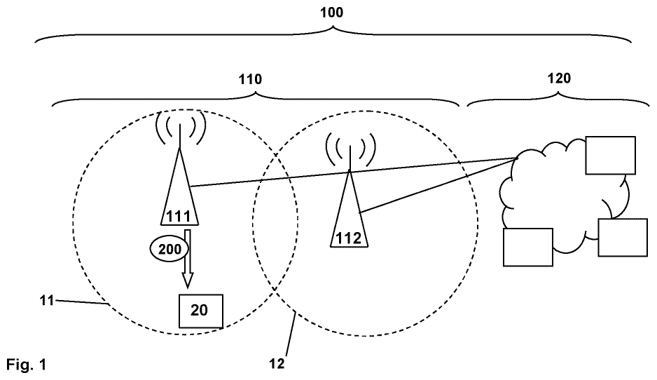

In FIG. 1, a telecommunications network 100 comprising an access network 110, and a core network 120 is schematically shown. The telecommunications network 100 or also mobile communication network 100 is typically realized as a cellular network or cellular mobile communication network 100. The telecommunications network 100, especially the core network 120, typically comprises a number of network functions or services (which are, however, not explicitly indicated via reference signs in FIG. 1). Examples of such network functions or services include, e.g., an access and mobility management function, AMF, and/or a user plane function, UPF-especially in case of a 5G telecommunications network, in which case the core network 120 might also be called a 5G core (system) and the access network 110 or radio access network 110 a next-generation radio access network, NG-RAN. The access network 110 comprises a plurality of radio cells 11, 12, i.e. geographical areas are served, respectively, by base station entities. In the exemplary situation or scenario shown in FIG. 1, a first base station entity 111 generates or is associated with or spans the first radio cell 11, and a second base station entity 112 generates or is associated with or spans the second radio cell 12. The base station entities 111, 112 typically realize gNodeB (gNB) functionality or next-generation gNB functionality. The telecommunications network 100 is typically connected to a plurality of user equipments 20 (or, rather, the user equipments 20) are connected to the telecommunications network 100); however, for the sake of simplicity, only one of such user equipments 20 is schematically shown in FIG. 1.

As it is generally and conventionally known, such mobile communication networks 100 provide the possibility to transmit data between the user equipment 20 and the base station entity 111 in downlink direction and/or in uplink direction.

In conventionally known mobile communication networks 100, there is currently no standardized control (or control architecture) on when (i.e. at which point in time) data-especially user plane data—is transmitted from the user equipment 20 in uplink direction. In downlink direction, it is the scheduler in the radio access network 110 (or, in the base station entity 111) that takes into account quality-of-service requirements of the bearer used based on service requirements and negotiated policy between the subscriber (i.e. the user equipment 20) and the operator and can schedule data in a way that transmission over the radio interface is optimized in terms of network efficiency and throughput, less based on energy-efficiency considerations.

Hence, what is lacking in conventionally known mobile communication networks is an active control architecture towards the user equipments regarding when the user equipment 20 should be allowed to actively transmit data based on load, capacity and energy consideration over longer term time scales.

According to the present invention, it is advantageously possible to provide a fine-grained control architecture and control signaling in order to possibly shift data transmissions in time and to enable data transmission more efficiently, especially in a more energy-efficient manner. Especially according to the present invention, the control signaling regarding such data transmission is especially based on standard protocols to control the data activity of the user equipment 20 generally and not once the user equipment 20 has already initiated a connection with the mobile communication network 100, i.e. especially not limited to the situation that the user equipment has already initiated such connection.

Especially, according to the present invention, in order to use the user equipment 20 with the mobile communication network, especially with the base station entity 111, the base station entity 111 first transmits a transmission opportunity information 200 (to the user equipment 20). The transmission opportunity information 200 indicates the possibility for the user equipment 20 to transmit data in uplink direction and/or the possibility for the user equipment 20 to request the transmission of data in downlink direction. After reception of the transmission opportunity information 200, the user equipment 20 might use the content of the transmission opportunity information 200 (e.g. the possible time slots and/or the possible network slices, etc.—thus, the possibility or possibilities as indicated via the transmission opportunity information 200) in order to request data transmission in either uplink direction or in downlink direction or in both uplink and downlink direction.

Especially according to the present invention, the transmission opportunity information 200 indicates the possibility for the user equipment 20 to transmit data in uplink direction and/or the possibility for the user equipment 20 to request the transmission of data in downlink direction applying a certain granularity via using at least one out of the following:
the transmission opportunity information 200 indicates the possibility or possibilities to transmit data to be generally available,
the transmission opportunity information 200 is related to or inviting one traffic type or certain traffic types, especially broadband traffic or internet-of-things traffic,
the transmission opportunity information 200 is related to or inviting traffic being related to one 5QI value or to certain 5QI values,
the transmission opportunity information 200 is related to or inviting traffic being related to or transmitted using one bearer type or to certain bearer types,
the transmission opportunity information 200 is related to or inviting traffic being related to or transmitted using one network slice or to certain network slices, especially allowed network slices and/or subscribed network slices and/or active network slices.

It is especially preferred that the transmission opportunity information 200 is used—via indicating the possibility for the user equipment 20 to transmit data in uplink direction and/or the possibility for the user equipment 20 to request the transmission of data in downlink direction—to invite or incite data transmission and/or traffic, especially due to a currently detected or anticipated situation of comparatively low load of either the mobile communication network 100 or the air interface between the user equipment 20 and the base station entity 111 and/or due to a currently detected or anticipated situation of comparatively low data transmission costs especially in terms of energy prices, especially in case of abundant eco-friendly power availability. This especially applies to delay-tolerant traffic and/or traffic that is either expected to definitively need to be transmitted at some later point in time, or traffic where, at least partly, only a potential need to be transmitted is expected.

Especially, the transmission opportunity information 200 refers to the possibility or possibilities to use one or a plurality of network slices, in which case the transmission opportunity information 200 might be transmitted as a bitmap information, especially a bitmap information transmitted using a suitable system information block, SIB. Especially, the bitmap information refers to specific network slices, especially using a reference to one or a plurality of network slices and/or of pieces of slice/service type, SST, information of network slices.

Especially, the transmission opportunity information 200 refers to one or a plurality of configured network slices which configured network slices (or, rather, reference information thereto) are transmitted, by the base station entity 111 and/or the mobile communication network 100, to the user equipment 20. Especially, the bitmap information (as the transmission opportunity information 200) refers to such configured network slices, and especially either indicates, to the user equipment 20 and regarding each one of such configured network slices, the possibility to use transmit data in uplink direction and/or the possibility for the user equipment 20 to request the transmission of data in downlink direction.

The bitmap information especially comprises, regarding each one of such configured network slices,
either one bit regarding the possibility to use transmit data in uplink direction and/or the possibility for the user equipment 20 to request the transmission of data in downlink direction,
or one bit regarding the possibility to use transmit data in uplink direction and another bit regarding the possibility for the user equipment 20 to request the transmission of data in downlink direction.

The transmission opportunity information 200 furthermore especially comprises a start time indication and/or an end time indication and/or a data volume or data amount indication regarding the invitation or the incitation for the user equipment 20 to transmit data in uplink direction and/or the invitation or the incitation for the user equipment 20 to request the transmission of data in downlink direction,
especially a start time indication and/or an end time indication and/or a data volume or data amount indication per configured network slice,
wherein especially the start time indication is implicitly provided via transmitting the transmission opportunity information 200 and wherein the transmission opportunity information 200 comprises a duration information indicating the end time information, especially a duration information per configured network slice,
wherein especially the duration information indicates—regarding the invitation or the incitation for the user equipment 20 to transmit data in uplink direction and/or the invitation or the incitation for the user equipment 20 to request the transmission of data in downlink direction—a duration of 10 seconds, or of 20 seconds, or of 30 seconds, or of 45 seconds, or of 60 seconds, or of 90 seconds, or of 2 minutes, or of 3 minutes, or of 4 minutes, or of 5 minutes, or of 6 minutes, or of 8 minutes, or of 10 minutes, or of 15 minutes, or of 20 minutes, or of 25 minutes, or of 30 minutes, or of 45 minutes, or of 60 minutes, or of 90 minutes, or of 2 hours, or of 3 hours, or of 4 hours, or of 5 hours, or of 6 hours.

The user equipment 20 is typically able to have at least one of the following radio resource control states: idle, inactive and connected, wherein the transmission opportunity information 200 is especially used and/or applied, by the user equipment 20, if in a radio resource control state idle or inactive or connected, wherein especially the transmission opportunity information 200 is transmitted using common control signaling and/or dedicated control signaling, wherein especially common control signaling is used in case that the user equipment 20 is currently in radio resource control states idle or inactive and wherein especially dedicated control signaling is used in case that the user equipment 20 is currently in radio resource control state connected.

According to the present invention, in order to control the data transmission of a 5G user equipment 20 in a cellular network in RRC_IDLE (in turn triggering an RRC connection) or RRC_INACTIVE (triggering the active resume or the stalled connection) state two schemes could be used:
Common Control Signaling (via BCH: this would be valid for all user equipments in a particular radio cell) (or, common Control Signaling partitioned (via BCH valid for different groups of user equipments in a particular radio cell)) or
Dedicated Control Signaling (via DCH valid for only one particular user equipment 20 (and, obviously, multiple messages for different user equipment 20 are needed).

Both schemes can also be applied for a user equipment 20 in RRC CONNECTED state, while the dedicated control signaling would be more straight forward for this scenario.

It can be further distinguished for the above on the granularity of the validity (as contained in the transmission opportunity information 200):
Common for all data activity of the user equipment (i.e. generally),
Differentiated based on traffic types (Broadband, IoT, . . . ),
Differentiated based on 5QI/bearer type (e.g. 5QI=8),
On the granularity of network slices (S-NSSAI), (Allowed/Subscribed/Active).

The structure of the S-NSSAI (Single Network Slice Selection Assistance Information) is such that is comprises a part corresponding to the Slice/Service Type, SST, information, and another part corresponding to the Slice Differentiator, SD. The S-NSSAI may include both the SST and SD fields (in which case the S-NSSAI length is 32 bits in total), or the S-NSSAI may just include the SST field (in which case the S-NSSAI length is 8 bits only). The SST is between 0 and 255 (256 values) and can be directly used as a metric to control/trigger the data per network slice.

In the simplest form, a new SIB would need to be introduced with, e.g., the following structure:

### SST Bitmap (256 Bits):

Invite date for:
1000010010010001000000001001000010 . . . 1000 (def.: Leftmost SST=0)

### Optional Duration Timer Per Activated SST

$$SST 0 = x ( ms / s / min )$$

$$SST 5 = x ( ms / s / min )$$

$$SST 8 = x ( ms / s / min )$$

### Optional Data Amount Per Activated SST

$$SST 0 = y ( bytes / kbytes / Mbytes )$$

$$SST 5 = y ( bytes / kbytes / Mbytes )$$

$$SST 8 = y ( bytes / kbytes / Mbytes )$$

A similar formation of signaling could be used on the decided control channel.

While subject matter of the present disclosure has been illustrated and described in detail in the drawings and foregoing description, such illustration and description are to be considered illustrative or exemplary and not restrictive. Any statement made herein characterizing the invention is also to be considered illustrative or exemplary and not restrictive as the invention is defined by the claims. It will be understood that changes and modifications may be made, by those of ordinary skill in the art, within the scope of the following claims, which may include any combination of features from different embodiments described above.

The terms used in the claims should be construed to have the broadest reasonable interpretation consistent with the foregoing description. For example, the use of the article “a” or “the” in introducing an element should not be interpreted as being exclusive of a plurality of elements. Likewise, the recitation of “or” should be interpreted as being inclusive, such that the recitation of “A or B” is not exclusive of “A and B,” unless it is clear from the context or the foregoing description that only one of A and B is intended. Further, the recitation of “at least one of A, B and C” should be interpreted as one or more of a group of elements consisting of A, B and C, and should not be interpreted as requiring at least one of each of the listed elements A, B and C, regardless of whether A, B and C are related as categories or otherwise. Moreover, the recitation of “A, B and/or C” or “at least one of A, B or C” should be interpreted as including any singular entity from the listed elements, e.g., A, any subset from the listed elements, e.g., A and B, or the entire list of elements A, B and C.

1-11. (canceled)

12. A method for operating a user equipment in or with a mobile communication network comprising a radio access network, wherein the radio access network comprises at least one base station entity, wherein data transmission is able to be conducted, between the user equipment and the base station entity and using an air interface between them, in downlink direction, involving data being transmitted by the base station entity and received by the user equipment, or in uplink direction, involving data being transmitted by the user equipment and received by the base station entity,
wherein, in order to use the user equipment with the mobile communication network the method comprises the following steps:
in a first step, the base station entity transmits, and the user equipment receives, a transmission opportunity information to invite or incite data transmission and/or traffic due to a currently detected or anticipated situation of comparatively low load of either the mobile communication network or the air interface between the user equipment and the base station entity, wherein the transmission opportunity information indicates the possibility for the user equipment to transmit data in uplink direction or the possibility for the user equipment to request the transmission of data in downlink direction; and
in a second step, data transmission in either uplink direction or in downlink direction occurs, between the user equipment and the base station entity, according to the possibility or possibilities as indicated by means of the transmission opportunity information,
wherein the transmission opportunity information is transmitted as a bitmap information,
wherein the bitmap information refers to such configured network slices, and either indicates, to the user equipment and regarding each one of such configured network slices, the possibility to use transmit data in uplink direction or the possibility for the user equipment to request the transmission of data in downlink direction,
wherein the bitmap information comprises, regarding each one of such configured network slices,
either one bit regarding the possibility to use transmit data in uplink direction or the possibility for the user equipment to request the transmission of data in downlink direction,
or one bit regarding the possibility to use transmit data in uplink direction and another bit regarding the possibility for the user equipment to request the transmission of data in downlink direction.

13. The method according to claim 12, wherein the transmission opportunity information indicates the possibility for the user equipment to transmit data in uplink direction or the possibility for the user equipment to request the transmission of data in downlink applying a certain granularity by means of using at least one out of the following:
the transmission opportunity information indicates the possibility or possibilities to transmit data to be generally available,
the transmission opportunity information is related to or inviting one traffic type or certain traffic types,
the transmission opportunity information is related to or inviting traffic being related to one 5QI value or to certain 5QI values,
the transmission opportunity information is related to or inviting traffic being related to or transmitted using one bearer type or to certain bearer types,
the transmission opportunity information is related to or inviting traffic being related to or transmitted using one network slice or to certain network slices.

14. The method according to claim 12, wherein the invited or incited data transmission and/or traffic involves delay-tolerant traffic and/or traffic that is either expected to definitively need to be transmitted at some later point in time, or traffic where, at least partly, only a potential need to be transmitted is expected, wherein the invited or incited data transmission and/or traffic involves software updates or firmware updates or map updates, logging data.

15. The method according to claim 12, wherein—especially in case that the transmission opportunity information refers to the possibility or possibilities to use one or a plurality of network slices—the transmission opportunity information is transmitted as a bitmap information,
wherein the bitmap information is referring to specific network slices,
wherein the bitmap information is potentially able to address up to 256 different network slices and/or pieces of slice/service type, SST, information.

16. The method according to claim 12, wherein the transmission opportunity information comprises a start time indication and/or an end time indication and/or a data volume or data amount indication regarding the invitation or the incitation for the user equipment to transmit data in uplink direction or the invitation or the incitation for the user equipment to request the transmission of data in downlink direction, a start time indication and/or an end time indication and/or a data volume or data amount indication per configured network slice,
wherein the start time indication is implicitly provided by means of transmitting the transmission opportunity information and wherein the transmission opportunity information comprises a duration information indicating the end time information, especially a duration information per configured network slice.

17. The method according to claim 12, wherein the user equipment is able to have at least one of the following radio resource control states:
idle,
inactive and
connected,
wherein the transmission opportunity information is used and/or applied, by the user equipment, if in a radio resource control state idle or inactive or connected,
wherein the transmission opportunity information is transmitted using common control signaling and/or dedicated control signaling, wherein common control signaling is used in case that the user equipment is currently in radio resource control states idle or inactive and wherein dedicated control signaling is used in case that the user equipment is currently in radio resource control state connected.

18. A user equipment for being operated in or with a mobile communication network, wherein the mobile communication network comprises a radio access network, wherein the radio access network comprises at least one base station entity, wherein data transmission is able to be conducted, between the user equipment and the base station entity and using an air interface between them, in downlink direction, involving data being received by the user equipment, or in uplink direction, involving data being transmitted by the user equipment,
wherein, in order to use the user equipment with the mobile communication network, the user equipment is configured such that:
the user equipment receives a transmission opportunity information to invite or incite data transmission and/or traffic due to a currently detected or anticipated situation of comparatively low load of either the mobile communication network or the air interface between the user equipment and the base station entity, wherein the transmission opportunity information indicates the possibility for the user equipment to transmit data in uplink direction or the possibility for the user equipment to request the transmission of data in downlink direction; and
data transmission in either uplink direction or in downlink direction occurs, between the user equipment and the base station entity, according to the possibility or possibilities as indicated by means of the transmission opportunity information,
wherein the transmission opportunity information is transmitted as a bitmap information,
wherein the bitmap information refers to such configured network slices, and either indicates, to the user equipment and regarding each one of such configured network slices, the possibility to use transmit data in uplink direction or the possibility for the user equipment to request the transmission of data in downlink direction,
wherein the bitmap information comprises, regarding each one of such configured network slices,
either one bit regarding the possibility to use transmit data in uplink direction or the possibility for the user equipment to request the transmission of data in downlink direction,
or one bit regarding the possibility to use transmit data in uplink direction and another bit regarding the possibility for the user equipment to request the transmission of data in downlink direction.

19. A system or mobile communication network for operating a user equipment in or with a mobile communication network comprising a radio access network, wherein the radio access network comprises at least one base station entity, wherein data transmission is able to be conducted, between the user equipment and the base station entity and using an air interface between them, in downlink direction, involving data being transmitted by the base station entity and received by the user equipment, or in uplink direction, involving data being transmitted by the user equipment and received by the base station entity,
wherein, in order to use the user equipment with the mobile communication network, the system or mobile communication network is configured such that:
the base station entity transmits, and the user equipment receives, a transmission opportunity information to invite or incite data transmission and/or traffic due to a currently detected or anticipated situation of comparatively low load of either the mobile communication network or the air interface between the user equipment and the base station entity, wherein the transmission opportunity information indicates the possibility for the user equipment to transmit data in uplink direction or the possibility for the user equipment to request the transmission of data in downlink direction,
data transmission in either uplink direction or in downlink direction occurs, between the user equipment and the base station entity, according to the possibility or possibilities as indicated by means of the transmission opportunity information,
wherein the transmission opportunity information is transmitted as a bitmap information,
wherein the bitmap information refers to such configured network slices, and either indicates, to the user equipment and regarding each one of such configured network slices, the possibility to use transmit data in uplink direction or the possibility for the user equipment to request the transmission of data in downlink direction,
wherein the bitmap information comprises, regarding each one of such configured network slices,
either one bit regarding the possibility to use transmit data in uplink direction or the possibility for the user equipment to request the transmission of data in downlink direction,
or one bit regarding the possibility to use transmit data in uplink direction and another bit regarding the possibility for the user equipment to request the transmission of data in downlink direction.

20. A program comprising a computer readable program code which, when executed on a computer or on a user equipment, or on a base station entity or on a radio access network node, or in part on a user equipment and/or in part on a base station entity and/or in part on a radio access network node, causes the computer or the user equipment or the base station entity or the radio access network node to perform a method according to claim 12.

21. A computer readable medium comprising instructions which, when executed on a computer or on a user equipment, or on a base station entity or on a radio access network node, or in part on a user equipment and/or in part on a base station entity and/or in part on a radio access network node, causes the computer or the user equipment or the base station entity or the radio access network node to perform a method according to claim 12.
